(19) United States
(12) Patent Application Publication
(10) Pub. No.: US 2024/0157863 A1
(43) Pub. Date: May 16, 2024

(54) SYSTEM AND METHOD FOR ASSESSING BATTERY CAPACITY AND FEATURE FUNCTIONALITY OPTIMIZATION

(71) Applicant: Lear Corporation, Southfield, MI (US)

(72) Inventors: Sumanth MUTHYALA, Ann Arbor, MI (US); Arjun YETUKURI, Rochester Hills, MI (US); Jose Gabriel FERNANDEZ BANARES, Valls (ES)

(21) Appl. No.: 17/987,074

(22) Filed: Nov. 15, 2022

(51) Int. Cl. B60N 2/90; B60L 1/00; B60N 2/00

(52) U.S. Cl. CPC B60N 2/90; B60L 1/00; B60N 2/002

(57) ABSTRACT

In at least one embodiment, a system including a seat assembly and at least one controller is provided. The seat assembly performs one or more seat operations for a vehicle occupant. The at least one controller is programmed to receive a first signal indicative of battery charge status for one or more batteries and to control the one or more seat operations based on at least the battery charge status.

### TECHNICAL FIELD

Aspects disclosed herein generally relates to a system and a method for assessing battery capacity and feature functionality optimization. These aspects and others will be discussed in more detail herein.

### BRIEF DESCRIPTION OF THE DRAWINGS

FIG. 1 depicts a first system for assessing battery capacity and feature functionality optimization in accordance with one embodiment;

FIG. 2 depicts a second system for assessing battery capacity and feature functionality optimization in accordance with one embodiment;

FIG. 3 depicts a method for assessing battery capacity and for performing feature functionality optimization in accordance with one embodiment;

FIG. 4 depicts a method for adjusting seat functionality based on desired destination for a user in accordance with one embodiment; and

FIG. 5 depicts another method for adjusting seat functionality based on desired destination for a user in accordance with another embodiment.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” and/or “at least one” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

One or more batteries power features and components of an electric vehicle (EV). Certain vehicle functions may repeat the use of vehicle features that may require a higher current draw. This higher current draw may negatively impact the driving range for the EV (i.e., reduces the driving range of the EV). Possible outcomes may include unexpected delays on a trip thus requiring recharging stops or slower travel. In addition, as the EV ages, a majority of battery capacity is allocated towards supporting the driving range. As the demand on batteries increases for powered operations in the EV, there is a need for optimization of battery usage and/or feature use.

Aspects disclosed herein may alleviate driving range anxiety by: (i) evaluating feature function demand versus available battery life and then providing an alert to the driver, (ii) performing internal optimization of battery usage for primary function and range, and/or (iii) performing feature usage management for battery optimization while enabling auxiliary feature functions, such as those as set forth below in connection with one or more of the figures. The disclosed systems and methods assess battery capacity and controls seat functionality based on the assessed battery capacity.

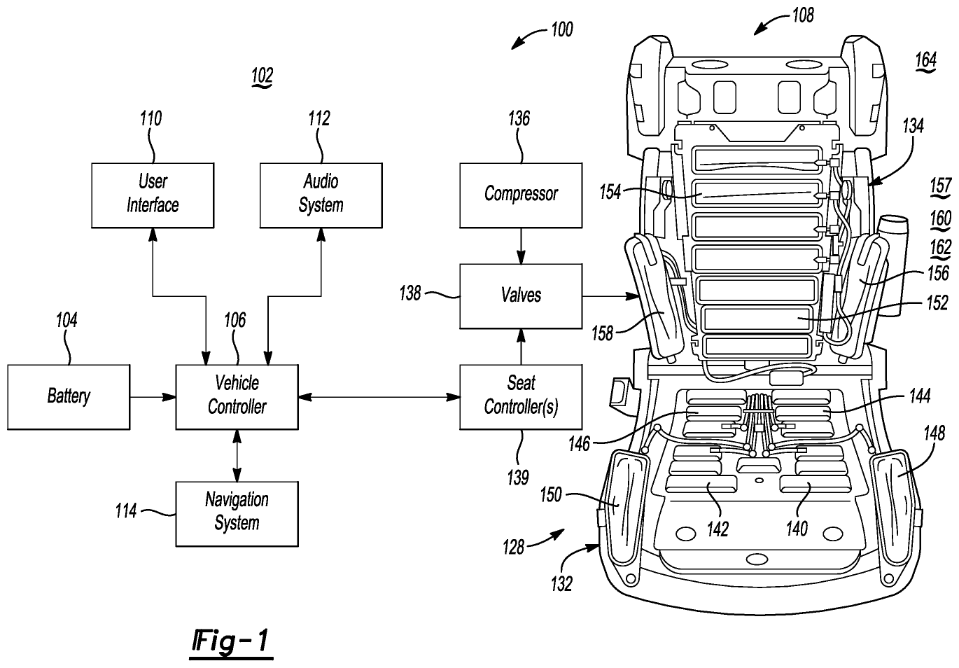

FIG. 1 depicts a first system 100 for assessing battery capacity and feature functionality optimization in accordance with one embodiment. The first system 100 may be implemented in a vehicle 102. The vehicle 102 may be a battery electric vehicle (BEV), a hybrid electric vehicle (HEV), plug-in-electric vehicle (PHEV), or a fuel cell electric vehicle (FCEV). The first system 100 includes at least one battery 104 (hereafter “the battery 104”), a vehicle controller 106, and at least one seat 108 assembly (hereafter “the seat assembly 108”). In general, the vehicle controller 106 monitors or assess battery capacity of the battery 104. The vehicle controller 106 controls, via at least one seat controller 139 (the seat controller 139), seat functionality based on the battery capacity of the battery 104. In one example, battery capacity generally corresponds to a state of charge (SoC) of the battery 104. For example, the vehicle controller 106 may monitor voltage and/or current that is remaining on the battery 104 over a time interval. In the event the vehicle controller 106 determines that the battery capacity may negatively impact range of the vehicle 102, the vehicle controller 106 may control vehicle features in an attempt to maximize or otherwise prolong battery charge to ensure the vehicle 102 reaches its desired final destination. In one example, the vehicle controller 106 may control seat features/functionality based on battery usage, via the seat controller 139, as will be described in more detail below based on battery charge (or SoC). In this instance, the vehicle controller 106 may serve as a “master controller” and the seat controller 139 may serve as a “slave controller”. It is recognized that the seat controller 139 may also serve as a “master controller” in the event the driver (or passenger) selects any seat operation as set forth herein directly. It is recognized that the functionality performed by the vehicle controller 106 and the seat controller 139 as set forth herein may be performed independent of one another. Additionally, the functionality performed by the vehicle controller 106 and the seat controller 193 may be combined into a single unit/device and/or placed in other controllers (not shown) that are positioned in the vehicle 102.

The first system 100 further includes a user interface 110, an audio system 112, and a navigation system 114. It is recognized that each of the audio system 112 and the navigation system 114 may include any number of controllers for performing various operations as detailed herein. The relevance of the user interface 110, the audio system 112 and the navigation system 114 will be discussed in more detail below. It is recognized that the navigation system 114 may be part of a global positioning system (GPS) used by the vehicle 102 to perform vehicle navigation. It is also recognized that the

The seat assembly 108 in FIG. 1 is shown with a cover removed. The seat assembly 108 includes a seat cushion 132 arranged to be mounted for motor-driven adjustable translation in a fore and aft direction and in an up and down direction of the vehicle 102. The seat assembly 108 includes a seat back 134 pivotally connected to the seat cushion 132 such that the seat back 134 and the seat cushion 132 move together in a generally vertical orientation (e.g., up/down direction). A head restraint (not shown) is mounted for motor-driven adjustable translation with respect to the seat back 134.

At least one compressor 136 provides a source of air to the seat assembly 108. A plurality of valves 138 receive the compressed air and are controlled by the seat controller 139 for regulating compressed air into and out of the seat assembly 128. The seat cushion 132 includes a forward left (or inboard) air bladder 140, a forward (or outboard) right air bladder 142, a rear left air bladder 144, a rear right air bladder 146, a left side bolster air bladder 148, and a right-side bolster air bladder 150. The seat back 134 includes a plurality of lumbar air bladders 152, a plurality of thoracic air bladders 154, a left side bolster air bladder 156, and a right-side bolster air bladder 158. The valves 138 may be provided as a common valve bank that is housed in the seat back 134 or under the seat cushion 132; or the valves 138 may each be provided on each of the air bladders 140, 142, 144, 146, 148, 150, 152, 154, 156, 158. The compressor 136 may be provided in the seat back 134, the seat cushion 132 or concealed within the vehicle body. The seat controller 139 may be provided in a module under the seat cushion 132 and may be a multifunction controller that also controls other functions in the vehicle 102. The compressor 136 may provide compressed air to the various valves 138 to selectively inflate/deflate any one or more of the bladders 140, 142, 144, 146, 148, 150, 152, 154, 156, and 158 to massage anatomical features for the vehicle occupant positioned in the seat assembly 108.

In one example, one or more cooling ducts 160 and one or more cooling fans 162 may be positioned in the seat assembly 108. The cooling fan 162 circulates cooled air through the cooling ducts 160 to cool the occupant (e.g., driver or passenger) seated in the seat assembly 108. In addition, the seat assembly 108 may include perforations 164 to receive air (i.e., suck air inside the seat) to cool the occupant. The seat assembly 108 may also include heating elements 166 positioned in at least one of the seat cushion 132 and the seat back 134 to heat anatomical features for the vehicle occupant positioned in the seat assembly 108.

In general, the first system 100 may incorporate a comfort plan (or first mode) in which the seat assembly 108 activates features to limit discomfort for a driver and passengers of the vehicle 102 over drives of various distances that may be short or long (e.g., time and distance based). The vehicle controller 106, the user interface 110, the audio system 112, the navigation system 114, and the seat controller 139 may communicate with one another via a communication data bus. In one example, the communication data bus may be a Controller Area Network (CAN) bus. For example, the vehicle controller 106, the user interface 110, the audio system 112, the navigation system 114, and the seat controller 139 may transmit and receive signals to and from one another via the data communication bus. The navigation system 114 may provide travel time (e.g., time to reach the destination as entered by the vehicle occupant) to the vehicle controller 106. In turn, the vehicle controller 106 provides the travel time to the seat controller 139 to activate various seat features in a first mode (e.g., comfort mode or plan). The navigation system 114 may adjust the travel time based on delays due to traffic, etc., and provide updates to the seat controller 130 in real time via the vehicle controller 106. It is recognized that the navigation system 114 may also include a navigation system that is provided via a mobile device that is operably coupled to the vehicle 102.

Additional factors that may impact of influence the travel time involve the vehicle 102 identifying a series of parameters when a trip is started. Such parameters may involve distance, duration, altitude change, weather conditions, “straightness” of the trip, etc. Based on these parameters, battery energy consumption may be identified and mapped along the trip by the vehicle 102 to identify points where battery energy load might fall below a defined minimum threshold. For example, a long uphill section may have been identified, where the battery's energy consumption may be high and the stored energy will punctually reach below a minimum threshold. On the contrary, a prolonged descent in the route can suppose a recharge of energy, and that may allow a reduction in the defined minimum to ensure arrival at the destination.

Apart from this, the vehicle 102 may identify changes in the outlined travel plan. One example may involve the driver that stops to have a coffee or take some photos. Another example, may involve the vehicle 102 encountering a traffic jam, a stretch of rain or intense cold that places an unexpected load on the first system 100 (e.g., longer duration, windscreen wipers, heating, etc.). This change in the parameters of the trip can also be taken into account when identifying whether or not a functionality in the seat 139 has to enter a degraded mode to preserve battery charge.

The first system 100 may perform reference occupant recognition in which driving routines (e.g., dependent on times of day and activity) and/or driving posture habits (e.g., sit more upright in morning as opposed to being more relaxed in the afternoon or evening) to automatically adjust seating features for the occupant. Various biometric sensors 157 may be positioned on the seat assembly 108 and/or on a steering wheel (not shown) of the vehicle 102. In this case, the first system 100 may provide an adaptive comfort mode where continuous feedback is provided back to the seat controller 139 to maintain and/or improve comfort. The seat controller 139 may monitor physiological attributes (e.g., fidgeting, perspiration, drowsiness, blood pressure, etc.) of the vehicle driver and/or occupant and control seat features to optimize comfort for the driver and or vehicle occupant.

As noted above, the seat controller 139 may control various aspects of the seat assembly 108 in the comfort mode. The first system 100 may optimize seat control based on overcall SoC of the battery 104 to ensure that the vehicle 102 can reach its final destination based on the monitored battery charge. One example of the comfort mode as employed by the seat controller 139 without any optimization of seat functionality based on battery charge may include the following as described below.

One example of a seat operation that may be performed in the comfort mode may include a hot/cold (or heating/cooling) therapy as applied by the seat controller 139. This may involve, for example, the seat controller 139 activating a heated seat operation for the seat assembly 108 for a period of, for example, 10 to 15 minutes followed by a cooling operation of, for example, a few seconds. It is recognized that the time duration of the heating and cooling operation may vary. It also recognized that the time duration for the heating operation may be similar to the time duration for the cooling operation. In another example, the time duration for the heating operation may by different than the time duration for the cooling operation. The seat controller 139 may then allow for the seat assembly 108 to return to a previous temperature and then repeat the heating and cooling operations noted above. In the event the hot/cold therapy as employed by the seat controller 139 may be detected to adversely affect the vehicle's 102 ability to reach its final destination based on the monitored SoC of the battery 104, the vehicle controller 106 may control the seat controller 139 to revise the hot/cold therapy noted to ensure that the vehicle 102 can reach its final destination based on the measured SoC of the battery 104. For example, the revised hot/cold therapy may involve the seat controller 139 activating a heated seat operation for the seat assembly 108 for a period of 5 to 10 minutes followed by a cooling seat operation for a few seconds. The seat controller 139 may then allow for the seat assembly 108 to return to a normal temperature and then repeat the heating and cooling operation noted above. As can be seen, the seat controller 129 reduces the amount of time the heating operation is performed when it is necessary to optimize the comfort mode based on the SOC of the battery 104.

Under normal conditions, the seat controller 139 may also employ an injury therapy routine in the comfort mode. This may involve the seat controller 139 applying a heating operation on the seat assembly 108 for two minutes, then applying a cooling operation on the seat assembly 108 for one minute, then a heating operation for two minutes, then a cooling operation for one minute. In the event battery status (or charge) may negatively impact the vehicle's 102 ability to reach its final destination when employing the injury therapy routine, the seat controller 139 may apply a heating operation on the seat assembly 108 for example, for one minute, then apply a cooling operation on the seat assembly 108 for example, for 30 seconds, then a heating operation for example, for 30 seconds, and then a cooling operation for example, for 20 seconds.

In addition, under normal conditions, the seat controller 139 may also employ a yoga routine. This may involve the seat controller 139 employing a change in angle of the seat back 134 with respect to the seat cushion 132 for a change in lumbar extension (e.g., locally along erector spinae, scalene, etc.). For example, this aspect may involve changing an angle of the seat back 134 at 5 degrees for a duration of time and then returning the seat back 134 to an original recline angle for a certain number of cycles. In addition, the seat controller 129 may also selectively activate and deactivate bladders 152, 154, 156, 158 positioned in the seat back 134 to allow the user to adopt a spinal stretch, which may be repeated for a predetermined number of cycles. In addition, the audio system 112 may provide audible feedback to the vehicle occupant to instruct the occupant to push their respective back against the seat back 134 to also aid in stretching the spine. In the event the battery state (or charge) may negatively impact the vehicle's 102 ability to reach its final destination, the seat controller 139 may reduce the change in angle of the seat back 134, the number of cycles the seat back 134 is adjusted and/or reduce the number of cycles the bladders are inflated and deflated.

In addition, under normal conditions, the seat controller 139 may also employ an audio routine in response to user selection via the user interface 110. For example, the vehicle controller 106 may control the audio system 112 to play stress relieving music for a period of, 10 minutes. In the event the battery state (or charge) may negatively impact the vehicle's 102 ability to reach its final destination, the vehicle controller 106 may control the audio system 112 to play the stress relieving music for a shorter period, such as for example, 5 minutes.

In another example, under normal conditions, the seat controller 139 may also employ a thermal therapy in response to user selection via the user interface 110. This may involve the seat controller 139 rapidly cycling through hot and cold applications to the occupants back and lower body while positioned on the seat cushion 132 and the seat back 134. For example, the seat controller 139 may quickly oscillate from hot to cold or cold to hot at least one degree or greater per minute. This aspect may prevent nerve/muscle overload and trigger a reset of the vehicle occupant's muscles. The temperature therapy dilates the blood vessels (or provides vasodilation) when heat is applied. The temperature therapy constricts the blood vessels (or provides vasoconstriction) when cold temperatures are applied. The thermal therapy may remove toxins and provide a feeling of relaxation (e.g., like Scandinavian/Nordic Spas). In one example, heat may be applied for 10-15 minutes followed by a cold application for example, for a few seconds. The temperature may be allowed to return to a normal temperature to relax and the above may be repeated. For injury therapy, heat may be applied for example, for two minutes followed by a cold application for one minute, then followed by two minutes of hot temperatures, then followed by one minute of colder temperature, then following by two minutes of as much heat as the vehicle occupant can handle, and then one minute of as much cold temperature that the vehicle occupant can handle. In general, when battery status is determined to affect vehicle range, the vehicle controller 106 may control the seat controller 139 to reduce the time duration, reduce the number of cycles, and/or cancel the injury therapy routine.

Consider the example in which the vehicle 102 may undergo a 150-mile trip or a one-hour trip. To achieve comfort theory, biometrics, and human factors, the seat controller 139 may, for example, control the seat assembly 108 to perform the following:
Posture 1: Setting up an initial posture (50 miles or 20 min) with a massage at the end;
Posture 2: −1 degree upright, with a 20% inflation of bolsters or bladders (for example, 25 miles or 10 min);
Posture 3: (from Posture 1) one deg reclined and a 20% deflation of bolsters or bladders; and

Followed by back to initial posture (for next 50 miles or 20 min) and a thermal & audio therapy.

In the event battery status may affect vehicle range, the seat controller 139 may, for example, control the seat assembly 108 to (i) maintain Posture 1 (see above) for a longer distance and/or duration, (ii) reduce the massage duration at the end of Posture 1, (iii) for Posture 2, reduce the distance, duration, inflation/deflation rate and/or magnitude, and (iv) continue to maintain Posture 3 as noted above.

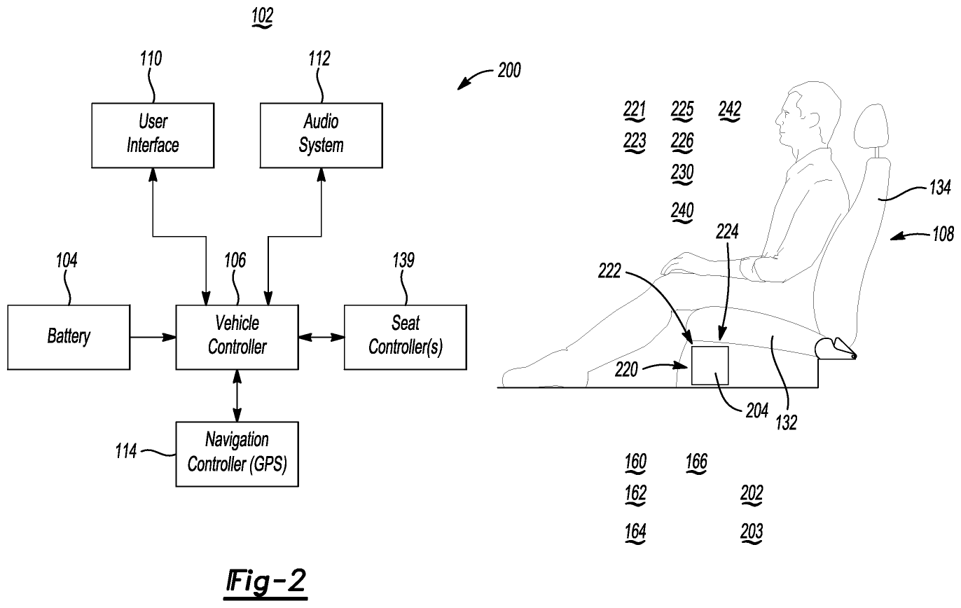

FIG. 2 depicts a second system 200 for assessing battery capacity and feature functionality optimization in accordance with one embodiment. The second system 200 includes the battery 104, the vehicle controller 106, the seat assembly 108, the user interface 110, the audio system 112, the navigation system 114, and the seat controller 139. A number of the components as set forth in connection with the first system 100 also apply to the seat assembly 108 as shown in FIG. 2. The seat assembly 108 includes a cushion length extender (CLE) 202 that is operatively connected to the seat cushion 132. The seat controller 139 may control the CLE 202 to move in fore or aft directions along a longitudinal axis in vehicle 102 to support and underside of legs (e.g., thighs and/or calves) for the driver or passenger positioned on the seat assembly 108. In addition, the CLE 202 may include the one or more cooling ducts 160 and the one or more cooling fans 162 to cool the underside of the legs (thighs and/or calves). The CLE 202 may also include the heating elements 166 to heat the underside of the legs (e.g., thighs and/or calves) of the vehicle occupant. It is also recognized that the CLE 202 may also include one or bladders 203 or micro-vibrators 204 to massage the underside of the legs (e.g., thighs and calves). The second system 200 may also control various aspects related to the CLE 202 in the comfort mode based on battery capacity.

As noted above, the seat controller 139 may control various aspects of the seat assembly in the comfort mode. The seat controller 139 may control the following aspects relative to the CLE 202 in the comfort mode. In addition, the second system 200 may optimize seat control relative to the CLE 202 based on overcall SoC of the battery 104 to ensure that the vehicle 102 can reach its final destination based on the monitored battery charge.

Under normal conditions, the second system 200 may employ a restless leg syndrome that may be selected via the user interface 110. In this example, the seat controller 139 may control the bladders 203 positioned in the CLE 202 to provide a massage to the underside of the legs (e.g., thigh and/or calves) of the vehicle occupant. In this case, the seat controller 139 may control the compressor 136 to provide for example, a 70 to 80% inflation level to bladders 203 at the waterfall area 220 of the CLE 202, bladders at a knee level 222 of the CLE 202, and bladders at a thigh level 224 the CLE 202. The bladders 203 may provide a massage to the calves and thighs of the vehicle occupant. In addition, the seat controller 139 may also apply cooling or heating to the underside of the legs (e.g., thigh and calves) of the vehicle occupant at temperatures between, for example, 41-43° C. at the skin level. In the event the battery state (or charge) may negatively impact the vehicle's ability to reach its final destination, the vehicle controller 106 may control the seat controller 139 to perform any one or more of: (i) reducing the magnitude of inflation of the bladders 140, 142, 144, 146, 148, 150, 152, 154, 156, and 158, (ii) reducing the frequency of inflation/deflation cycles for the bladders 140, 142, 144, 146, 148, 150, 152, 154, 156, and 158, (iii) reducing massage duration, (iv) reducing the amount of heating or cooling, (v) reducing the duration of heating and cool, and/or (vi) canceling any one or more of the above noted aspects.

In addition, under normal conditions, the second system 200 may employ a knee osteoarthritis therapy in response to user selection via the user interface 110. In this example, the seat controller 139 may control the bladders 203 positioned proximate to the vehicle occupant's knees to provide pulsated electromagnetic fields (PEMF) (e.g., near a waterfall area 220 of the CLE 202). In addition, the seat controller 139 may also apply heat to the knees of the vehicle occupant at temperatures between, for example, 41-43° C. at the skin level. In the event the battery state (or charge) may negatively impact the vehicle's ability to reach its final destination, the vehicle controller 106 may control the seat controller 139 to: (i) reduce the time duration of PEMF application, (ii) reduce the time duration of the heat application, and/or (iii) reduce the magnitude of the heating application. Each of the above aspects may be performed together as a combination, or partially with a subset of available comfort features.

Also under normal conditions, the second system 200 may employ a thrombosis prevention therapy in response to user selection via the user interface 110. In this case, the seat controller 139 may control the compressor 136 to intermittently provide, for example, up to 80% inflation level to bladders 203 at the waterfall area 220 of the CLE 202, bladders at the knee level 222 of the CLE 202, and bladders 203 at the thigh level 224 the CLE 202. This may be followed by cooling to be applied to the waterfall area 220 and the bladders 203 at the calf level of the CLE 202. In the event the battery state (or charge) may negatively impact the vehicle's ability to reach its final destination, the vehicle controller 106 may control the seat controller 139 to: (i) reduce a magnitude of inflation/deflation, (ii) reduce duration of inflation/deflation, (iii) reduce the number of cycles, and/or (iv) cancel one or more of the noted operations.

Also under normal conditions, the second system 200 may employ a tissue thermal shock operation in response to user selection via the user interface 110. This therapy may prevent bare skin thermal shock/discomfort due to extreme temperature conditions. For example, the seat controller 139 may apply cooling and heating at, for example, 41-43° C. at skin level (or at occupant preference) at the waterfall 220 of the CLE 202. In the event the battery state (or charge) may negatively impact the vehicle's ability to reach its final destination, the vehicle controller 106 may control the seat controller 139 to: (i) reduce the duration of the heating and cooling operation(s), (ii) reduce the magnitude of the heat applied, or (iii) cancel one or more of the noted operations

It is recognized that the second system 200 may also be utilized to perform aspects involving system function degradation with user participation in accordance with another embodiment. For example, the second system 200 may adapt system function degradation with user participation. In a first scenario, the second system 200, when the user enters the vehicle 102, or while the biometric sensors 157 monitor user biological parameters, the second system 200 may detect anomalies. The anomalies may include frowning via facial recognition, poor posture (e.g., “sunken” body in seat), etc. However, the second system 200 may provide different corrective actions. The second system 200 is configured to interact with the user. For example, the user interface 110 may prompt the user via audible inquiries (or questions) to identify what is causing the anomaly or diagnostics. The diagnostics may include, but not limited to, the second system 200 not knowing if the occupant is tired, angry or if there is a strange smell outside of the vehicle 102. In addition, the diagnostics may include, but not limited to, the second system 200 not knowing if the user's back hurt or if the occupant is “hiding” from someone outside of the vehicle 102. In this case, the user interface 110 may provide questions or inquiries that probe the user's mood, feeling, on-going thoughts, etc. It is recognized that an in-ward facing camera 221 may be positioned with the vehicle 102 to capture the user's moods or expressions. The in-ward facing camera 221 may be electrically coupled to the vehicle controller 106 to process images provided by the in-ward facing camera 221. The vehicle controller 106 may determine the user's mood or feeling based on the images provided by the in-ward facing camera 221. Based on the user's mood or feeling, the vehicle controller 106 may automatically activate a diagnostic to address the user's mood or feeling. In this instance, irrespective of charge status, the vehicle controller 106 may activate a seat control to address the user's issue as such an issue may pertain to a direct biological anomaly as expressed by the user while being interrogated by the user interface 110.

In another scenario, the second system 200 offers the user an option to define a user profile via the user interface 110. For example, the user may define various priorities when a particular degradation level is detected by the vehicle 102. The degradation levels will be discussed in more detail below. The user may define function priorities according to his/her physical ailments (e.g., back problems, knee problems, etc.). In this instance, when the vehicle 102 is experiencing a degradation mode, the vehicle controller 106 may control the seat controller 139 to keep the back massage operation on or activate to treat the user's back. Thus, in this regard, the user profile as established by the user provides priority items to ensure that features that are activated by the seat in order to address ailments associated with the priority items remain on or stay activated irrespective of the degradation mode or battery status.

The vehicle 102 may define various or different degradation levels (e.g., minimum, mild, or severe) and the user may program or identify which functions may be activated and/or deactivated when the vehicle 102 is experiencing such degradation levels. The second system 200 may automatically act in response to features as activated or deactivated in the user profile without prompting the user to take action when the vehicle 102 experiences a corresponding degradation mode. In another example, the user interface 110 may provide as the user or support an “ask me when needed” feature to allow the user to activate or deactivate the feature when the vehicle 102 experiences the degradation mode.

In another scenario, when the vehicle 102 (or vehicle controller 106) detects that it is entering into a degradation mode, the user interface 110 informs or prompts the user of the degradation level and the functions that will be degraded. At that point, the user may decide any one or more of the following: (i) not to degrade some functions, (ii) select alternative functions to reach the needed degradation, (iii) change the trip destiny to include a stop to recharge, to make the trip shorter, etc.), (iv) enter into a stronger degradation mode (i.e., perhaps since other trips lay ahead of the present trip), and (v) set a meeting (by phone call, on-line, etc.) in some time or distance with a mobile charging system, or similar.

The degradation levels may be defined by Original Equipment Manufacturers (OEM) or established by the user via the user interface 110 by selecting such aspects that form the degradation levels. In general, all vehicle loads may be characterized by a priority level. For example, electric driving 223 or anti-locking brakes (ABS) 225 may have a highest priority, while mood lights 226 in the vehicle 102 in the vehicle cabin may have the lowest priority. The following comprise a non-exhaustive listing of degradation levels:
Minimum Degradation Level Minimum:
   ECO mode disabling peak-speed or “sport-driving” mode, or
   reducing peaks of loads at their start (slower activations) or
   using energy reduction in very low priority loads (PWM supply, shorter activation periods, etc.)
Mild or medium
   A number of secondary functions are disabled (e.g., lumbar massage, rear video consoles 230, radio (or audio system 112), etc.
   Functions operate in degraded mode (slow operation, or high-power options disabled, etc.)
Severe
   Vehicle main functionality is restricted (e.g., seat electronics, heating or cooling (HVAC 240, accelerations or high engine revolutions, chromatic sunroof 242, automatic windows up and down 244, tire pressure, navigation system 114, main screen degraded (e.g., screen of user interface 110 degraded, etc.).

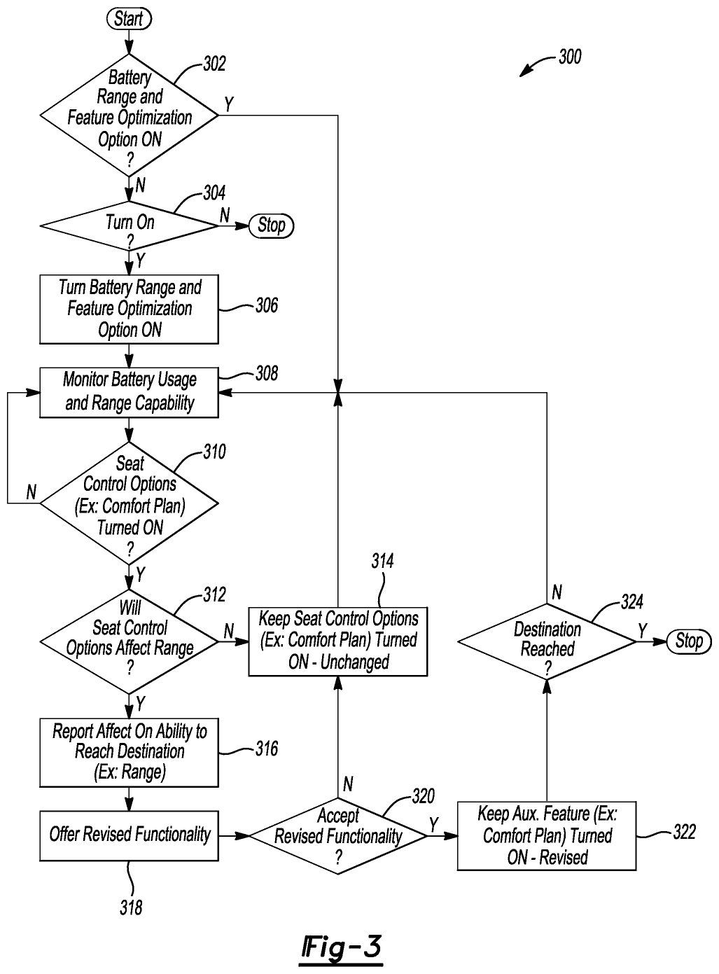

FIG. 3 depicts a method 300 for assessing battery capacity and for performing feature functionality optimization in accordance with one embodiment. While not shown in FIG. 3, the vehicle controller 106 may determine whether the vehicle 102 comes to stop (e.g., monitor brake status) on the way to the final destination and undergoes a recharging operation while executing any of the operations of the method 300. In the event this condition occurs, the method 300 exits and the seat assembly 108 may undergo normal operational usage.

In operation 302, the method 300 is initialized and the vehicle controller 106 determines whether the driver or passenger (e.g., user) has enabled the battery range and feature optimization option. The user may enable this option via a selectable switch (or audible command) via the user interface 110. If this feature is not enabled, the method 300 moves to operation 304. If so, the method 300 moves operation 308.

In operation 304, the user interface 110 provides a notification to the user and prompts the user if the user would like to activate the battery range and feature optimization option. If the user elects not to activate the battery range feature, then the method 300 comes to end. If the user activates the battery range feature, then the method 300 moves to operation 306.

In operation 306, the vehicle controller 106 receives a signal indicative of a request from the user interface 110 to activate (or turn on) the battery range feature. In operation 308, the vehicle controller 106 monitors battery usage and capacity/range capability of the battery 104. For example, the vehicle controller 106 may receive information, in real time, indicative of a distance to where the vehicle 102 is presently located relative to a final destination (including a final time to reach the final destination from where the vehicle is currently located) and the battery charge status to determine whether there is sufficient battery charge for the vehicle 102 to reach its final destination. In operation 310, the vehicle controller 106 determines whether the user has activated various seat control options (e.g., whether the seat assembly 108 is being controlled in the comfort mode). In general, the concept of battery range and feature optimization may be applied to any seat feature that draws current from the battery 104. If this condition is true, then the method 300 moves to operation 312. If not, then the method 300 moves back to operation 308.

In operation 312, the vehicle controller 106 determines whether the features that are activated in the comfort mode with respect to the seat assembly 108 will adversely affect the vehicle range (or the distance to the destination) with respect to battery capacity. For example, the vehicle controller 106 determines whether the battery charge status (or charge) may negatively impact the vehicle's ability to reach its final destination (or may prevent the vehicle from reaching its final destination based on the battery charge status). If this condition is not true, then the method 300 proceeds to operation 314. If this condition is true, then the method 300 proceeds to operation 316.

In operation 314, the vehicle controller 106 continues to allow the seat controller 139 to keep the seat features activated for the seat assembly 108 as desired by the user.

In operation 316, the vehicle controller 106 transmits an alert to the user interface 110 to notify the user that the seat features as activated in the comfort mode will adversely affect the vehicle's ability to reach its final destination since the activated seat features will negatively impact the battery's charge (or SoC).

In operation 318, the vehicle controller 106 may offer or generate an inquiry and transmit the inquiry, via the user interface 110, to the user to offer revised seat functionality that will not adversely impact the vehicle's ability to reach the desired or final destination. The revised seat functionality that may not adversely impact the vehicle's ability to reach the desired final destination based on the battery charge status may include the seat controller 139 (i) reducing a magnitude of inflation/deflation for the various bladders on the seat 108, (ii) reduce duration of inflation/deflation, (iii) reduce the number of cycles, and/or (iv) cancel one or more of the noted operations. In the event the battery state (or charge) may negatively impact the vehicle's ability to reach its final destination, the vehicle controller 106 may control the seat controller 139 to: (i) reduce the time duration of PEMF application, (ii) reduce the time duration of the heat application, and/or (iii) reduce the magnitude of the heating application. Each of the above aspects may be performed together as a combination, or partially with a subset of available comfort features.

In operation 320, the vehicle controller 106 determines, based on the user's response provided via the user interface 110, whether the user would like to proceed with the revised seat functionality or decline the revised seat functionality. If the user accepts the revised seat functionality, then the method 300 proceed to operation 322. If not, then the method 300 proceeds to operation 314. In operation 322, the vehicle controller 106 transmits a signal to the seat controller 139 to control various features of the seat assembly in accordance with the revised seat functionality.

In operation 324, the vehicle controller 106 determines whether the vehicle 102 has reached its final destination. For example, the vehicle controller 106 may receive a signal from the navigation system 114 that the vehicle has reached its final destination. If the final destination has been reached, then the method 300 stops. If the final destination has not been reached, then the method 300 proceeds back to operation 308.

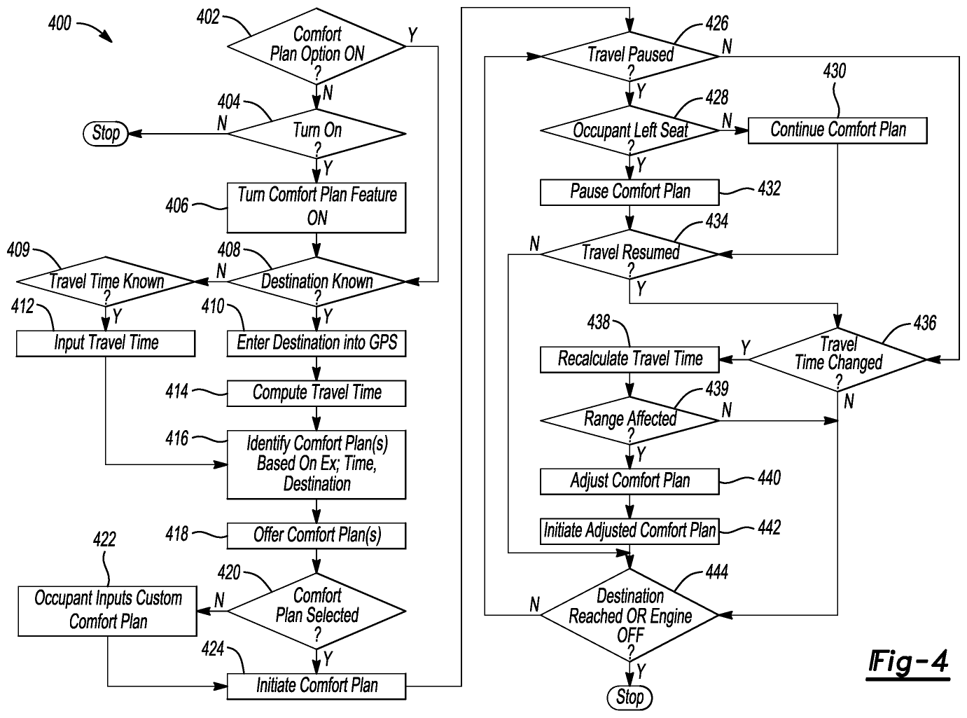

FIG. 4 depicts a method 400 for adjusting seat functionality based on desired destination for a user in accordance with one embodiment.

In operation 402, the vehicle controller 106 determines whether the comfort mode (e.g., any one or more of the operations noted in connection with FIGS. 1 and 2 that comprise the comfort mode has been activated by the occupant. These operations for the comfort mode may be activated via the user interface 110. If this condition is not true, then the method 400 moves to operation 404. If this condition is true, then the method 400 moves to operation 408.

In operation 404, the vehicle controller 106 receives a signal from the user interface 110 to activate one or more of the operations of the comfort mode. The vehicle controller 106 may transmit a signal indicative of the requested one or more operations of the comfort mode to the seat controller 129. In operation 406, the seat controller 129 activates the desired one or more operations of the comfort mode. In operation 408, the vehicle controller 106 determines whether the final destination of the vehicle 102 is known. The vehicle controller 106 may receive the final destination from the user interface 110 as entered by the occupant (or driver) of the vehicle 102. If this condition is not known, the method 400 moves to operation 410. In operation 410, the vehicle controller 106 determines if the travel time is known. In operation 412, the travel time may be input by the user via the user interface 110 or may be provided from a signal transmitted by the navigation system 114.

In operation 410, the vehicle controller 106 transmits the signal indicative of the final destination to the navigation system 114. In operation 414, the navigation system 114 computes the travel time. In operation 416, the vehicle controller 106 identifies the operation to be employed from the comfort mode based on the destination and the travel time to reach the final destination. For example, the vehicle controller 106 determines which operations of the comfort mode may be offered that will not adversely affect the vehicle's ability to reach its final destination.

In operation 418, the vehicle controller 106 transmits a signal indicative of operations of the comfort mode that are available for selection to the user interface 110. In turn, the user interface 110 provides the operations that are available for selection to the occupant/driver. In operation 418, the vehicle controller 106 may transmit at least two selections that are selectable by the driver. For example, the vehicle controller 106 may transmit a first option to the user interface 110 may offer a first option in which various seat features may be selected that does not adversely affect SoC and range. The vehicle controller 106 may also transmit a second option to the user via the user interface 110 for selection in which various seat features may be selected that adversely affects the SoC and range.

In operation 420, the vehicle controller 106 determines whether a signal has been received from the user interface 110 that is indicative of the occupant/driver's selection. In operation 420, the vehicle controller 106 determines if the occupant/driver has entered one or more custom features (or the first or second options as noted in connection with operation 418) of the comfort mode. If the occupant/driver has not entered one or more custom features of the comfort mode, then the method moves to operation 422. If so, then the method moves to operation 424.

In operation 422, the vehicle controller 106 receives one or more custom features of the comfort mode to execute. In operation 424, the vehicle controller 106 transmits a signal to the seat controller 139 to execute the selected one or more custom features of the comfort mode to execute relative to the seat assembly 108. In operation 426, the vehicle controller 106 determines whether the vehicle 102 has stopped or paused. The vehicle controller 106 may determine if the vehicle 102 has stopped or paused for a time period that exceeds a predetermined time interval which may negatively impact the time in which the vehicle 102 was expected to reach its final destination. In this case, the vehicle controller 106 may monitor brake status or information from the navigation system 114 which may indicate a prolonged pause or stop. If this condition is true, then the method 400 moves to operation 428. If not, then the method 400 moves to operation 436.

In operation 428, the vehicle controller 106 determines whether the occupant/driver has left his/her seat. The vehicle controller 106 may monitor door status to determine if the occupant/driver left the vehicle 102 (or seat 108). In addition, the seat 108 may include occupant sensors to provide an indication of whether an occupant or driver is positioned on a seat 108. If this condition it not true, the method 400 moves to operation 430 and continues executing the desired or selected one or more custom features of the comfort mode. If the occupant/driver has left his/her seat, then the method 400 moves to operation 432. In operation 432, the vehicle controller 106 controls the seat controller 129 to pause executing the selected one or more custom features of the comfort mode.

In operation 434, the vehicle controller 106 determines if the vehicle 102 has resumed travel. If not, then the method 400 moves to either operation 426 to determine if the vehicle 102 has paused again or moves to operation 444 to determine if the vehicle 102 has reached its desired destination. If operation 434 is true, then the method 400 moves to operation 436. In operation 436, the vehicle controller 106 determines if the travel time has changed due to the vehicle 102 pausing or stopping (or change or destination). If this condition is true, then the method 400 moves to operation 438. If not, then the method 400 moves to operation 444 to determine if the vehicle 102 has reached its final destination.

In operation 438, the vehicle controller 106 recalculates the travel time again attributed to the vehicle 102 exhibiting the pause. The vehicle controller 106 may receive a signal with the travel time being recalculated from the navigation system 114. In operation 439, the vehicle controller 106 determines whether the vehicle range (e.g., distance to final destination based on current charge status) is affected. In other words, if it takes longer for the vehicle 102 to reach its final destination as a result of the vehicle 102 pausing or the occupant leaving his/her seat, this condition may adversely affect the range of the vehicle which may require reducing seat operations to preserve battery charge status. If the vehicle controller 106 determines that the vehicle range is affected, then the method 400 moves to operation 440. If not, then the method 400 moves to operation 440.

In operation 440, the vehicle controller 106 adjusts the one or more selected operations of the comfort mode (e.g., see operation 318 and 320 as set forth in FIG. 3) based on the change in travel time and/or the change in the vehicle range of the vehicle 102. In operation 442, the vehicle controller 106 executes the adjusted comfort plan. As noted above, given that the above conditions may indicate that the travel time for the vehicle 102 to reach its final destination has increased, and that this condition may adversely impact battery charge status, the vehicle controller 106 may reduce various seat operations to preserve battery charge status to enable the vehicle 102 to reach its final destination. In operation 444, the vehicle controller 106 determines whether the vehicle 102 has reached its final destination based on information provided by the navigation system 114. Alternatively, the vehicle controller 106 determines whether the engine is in an OFF state (e.g., engine or key (e.g., vehicle) is OFF). If neither of these conditions are met, then the method 400 moves back to operation 426 and the method 400 is executed again from operation 426.

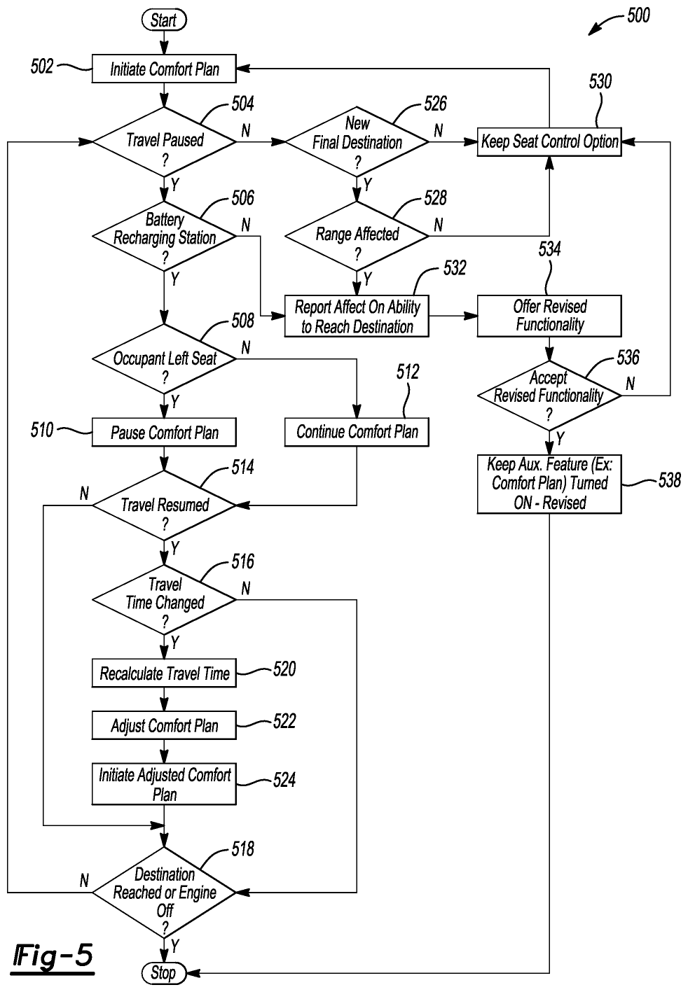

FIG. 5 depicts a method 500 for adjusting seat functionality based on desired destination for a user in accordance with another embodiment.

In operation 502, the vehicle controller 106 transmits a signal to the seat controller 139 to execute the selected one or more custom features of the comfort mode to execute relative to the seat assembly 108. In operation 504, the vehicle controller 106 determines whether the vehicle 102 has stopped or paused. If this condition is true, then the method 500 moves to operation 506. If not, then the method 500 moves to operation 526.

In operation 506, the vehicle controller 106 determines whether the vehicle 102 has reached a battery recharging station. The vehicle controller 106 may determine whether the vehicle 102 has reached the battery recharging station based on one or more signals received from the navigation system 114. Alternatively, or additionally, the vehicle controller 106 may determines that one or more batteries in the vehicle 102 are being charged which would also indicate that the vehicle 102 is at the battery recharging station. If this condition is true, then the method 500 moves to operation 532. If not, then the method 500 moves to operation 508.

In operation 508, the vehicle controller 106 determines whether the occupant/driver has left his/her seat. If this is true, then the method 500 moves to operation 510. If not, then the method 500 moves to operation 512 and continues executing the desired or selected one or more custom features of the comfort mode. In operation 510, the vehicle controller 106 controls the seat controller 129 to pause executing the selected one or more custom features of the comfort mode.

In operation 514, the vehicle controller 106 determines if the vehicle 102 has resumed travel. If not, then the method 500 moves to operation 518. If this is true, then the method 500 moves to operation 516. In operation 516, the vehicle controller 106 determines if the travel time has changed due to the vehicle 102 pausing or stopping (or change or destination). If this condition is true, then the method 500 moves to operation 520. If not, then the method 500 moves to operation 518 to determine if the vehicle 102 has reached its final destination has reached its final destination based on information provided by the navigation system 114. Alternatively, the vehicle controller 106 determines whether the engine is in an OFF state (e.g, engine or key (e.g., vehicle) is OFF).

In operation 520, the vehicle controller 106 recalculates the travel time again which is attributed to the vehicle 102 exhibiting the pause. The vehicle controller 106 may receive a signal with the travel time being recalculated from the navigation system 114. In operation 522, the vehicle controller 106 adjusts the one or more selected operations of the comfort mode (e.g., see operation 318 and 320 as set forth in FIG. 3. In operation 524, the vehicle controller 106 executes the adjusted comfort plan.

In operation 518, the vehicle controller 106 determines whether the vehicle 102 has reached its final destination based on information provided by the navigation system 114. Alternatively, the vehicle controller 106 determines whether the engine is in an OFF state (e.g, engine or key (e.g., vehicle) is OFF). If neither of these conditions are met, then the method 400 moves to back operation 502 and the method 300 is executed again from operation 502. If this condition is true, then the method 500 stops.

Moving back to operation 526, the vehicle controller 106 determines whether a new final destination has been selected by the driver. If this condition is true, then the method 500 moves to operation 528. If not, then the method 500 moves to operation 530. In operation 528, the vehicle controller 106 determines whether the vehicle range (e.g., distance to final destination based on current charge status) is affected. If so, the method 500 moves to operation 532. If not, then the method 500 moves to operation 530.

In operation 530, the vehicle controller 106 continues to allow the seat controller 139 to keep the seat features activated for the seat assembly 108 as desired by the user.

In operation 532, the vehicle controller 106 transmits an alert to the user interface 110 to notify the user that the seat features as activated in the comfort mode will adversely affect the vehicle's ability to reach its final destination since the activated seat features will negatively impact the battery's charge (or SoC).

In operation 534, the vehicle controller 106 may offer or generate an inquiry and transmit the inquiry, via the user interface 110, to the user to offer revised seat functionality that will not adversely impact the vehicle's ability to reach the desired or final destination.

In operation 536, the vehicle controller 106 determines, based on the user's response provided via the user interface 110, whether the user would like to proceed with the revised seat functionality or decline the revised seat functionality. If the user accepts the revised seat functionality, then the method 500 proceed to operation 538. If not, then the method 500 proceeds back to operation 530. In operation 538, the vehicle controller 106 transmits a signal to the seat controller 139 to control various features of the seat assembly in accordance with the revised seat functionality.

Item 1: in one embodiment, a system including a seat assembly and at least one controller is provided. The seat assembly performs one or more seat operations for a vehicle occupant. The at least one controller receives a first signal indicative of battery charge status for one or more batteries and controls the one or more seat operations based on at least the battery charge status.

Item 2: in another embodiment, the system of item 1, wherein the at least one controller receives a second signal indicative of a distance to a final destination for a vehicle.

Item 3: in another embodiment, the system of any of the preceding items, wherein the at least one controller controls the one or more seat operations based at least on the battery charge status and the final destination of the vehicle.

Item 4: in another embodiment, the system of any of the preceding items, wherein the at least one controller reduces functionality of the one or more seat operations to preserve battery charge status in response to determining that the vehicle will not reach the final destination based on the battery charge status.

Item 5: in another embodiment, the system of any of the preceding items, wherein the at least one controller reduces functionality of the one or more seat operations by performing one or more of: (i) reducing a magnitude of one of inflation and deflation for air bladders positioned on the seat assembly, (ii) reducing a time duration of the one of inflation and deflation for the air bladders, (iii) reducing a number of cycles that the air bladders are activated for, and (iv) cancelling the one of inflation and deflation for the air bladders.

Item 6: in one embodiment, the system of any of the preceding items, wherein the at least one controller reduces the functionality by performing one or more of: (i) reducing a time duration of applying pulsated electromagnetic fields (PEMF) application, (ii) reducing a time duration for applying a heating operation to the seat assembly, and (iii) reducing a magnitude of the heating operation to the seat assembly.

Item 7: in one embodiment, the system of any of the preceding items, wherein the at least one controller provides an inquiry on a user interface corresponding to an option for selection by a user to reduce the functionality of the one or more seat operations in response to determining that the vehicle will not reach the final destination based on the battery charge status.

Item 8: in one embodiment, the system of any of the preceding items, wherein the at least one controller reduces functionality of the one or more seat operations based at least on the battery charge status and the vehicle stopping to travel for a time period that exceeds a predetermined time interval.

Item 9: in one embodiment, the system of any of the preceding items, wherein the at least one controller determines that the vehicle occupant is no longer positioned on the seat assembly in response to an occupant detection signal.

Item 10: in one embodiment, the system of any of the preceding items, wherein the at least one controller determines a new travel time for the vehicle to reach the final destination in response to one of: (i) the vehicle stopping to travel for a time period that exceeds the predetermined time interval, and (ii) the vehicle occupant no longer being positioned on the seat assembly.

Item 11, in one embodiment, the system of any of the preceding items, wherein the at least one controller reduces functionality of the one or more seat operations in response to determining that the new travel time results in an increase in time in which the vehicle reaches the final destination.

Item 12, in one embodiment, the system of any of the preceding items, wherein the at least one controller determines that the vehicle has reached a battery charging station based on one or more of: (i) receiving information transmitted from a navigation system indicating that the vehicle has reached the battery charging station and (ii) detecting that the one or more batteries in the vehicle are being charged.

Item 13, in one embodiment, the system of any of the preceding items, wherein the at least one controller receives a third signal indicative of a distance to a new final destination for a vehicle.

Item 14: in one embodiment, the system of any of the preceding items, wherein the at least one controller controls the one or more seat operations based at least on the battery charge status and the new final destination of the vehicle.

Item 15: in one embodiment, the system of any of the preceding items, wherein the at least one controller receives an input signal indicative of the vehicle occupant's mood and controls the one or more seat operations based on the vehicle occupant's mood.

Item 16: in one embodiment, the system of any of the preceding items, wherein the at least one controller receives a profile signal indicative of a user profile for the vehicle occupant and selectively activates or deactivates the one or more seat operations based on the user profile.

Item 17: in one embodiment, the system of any of the preceding items, wherein the at least one controller selectively activates or deactivates the one or more seat operations without prompting the vehicle occupant.

Item 18: in one embodiment, the system of any of the preceding items, wherein the at least one controller controls one or more vehicle operations based on degradation levels.

Item 19: in one embodiment, a method is provided. The method includes executing, via at least one controller, one or more seat operations for a seat, receiving a first signal indicative of battery charge status for one or more batteries; and controlling the one or more seat operations based on at least the battery charge status.

Item 20: in one embodiment, a computer-program product embodied in a non-transitory computer read-able medium that is programmed for controlling one or more seat operations for a seat assembly, the computer-program product comprising instructions and being executed by at least one processor for (i) performing one or more seat operations for a seat assembly of a vehicle; (ii) receiving a first signal indicative of battery charge status for one or more batteries and (iii) controlling the one or more seat operations based on at least the battery charge status.

It is recognized that the controllers as disclosed herein may include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, such controllers as disclosed utilizes one or more microprocessors to execute a computer-program that is embodied in a non-transitory computer readable medium that is programmed to perform any number of the functions as disclosed. Further, the controller(s) as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The controller(s) as disclosed also include hardware-based inputs and outputs for receiving and transmitting data, respectively from and to other hardware-based devices as discussed herein. It is recognized that any controller as disclosed herein may be a standalone controller that may perform any of the noted operations. In another example, any number of controllers may be combined with one another to perform any one or more of the noted operations as also disclosed herein.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

What is claimed is:

1. A system comprising:
a seat assembly performing one or more seat operations for a vehicle occupant; and
at least one controller receiving a first signal indicative of battery charge status for one or more batteries and controlling the one or more seat operations based on at least the battery charge status.

2. The system of claim 1, wherein the at least one controller receives a second signal indicative of a distance to a final destination for a vehicle.

3. The system of claim 2, wherein the at least one controller controls the one or more seat operations based at least on the battery charge status and the final destination of the vehicle.

4. The system of claim 3, wherein the at least one controller reduces functionality of the one or more seat operations to preserve battery charge status in response to determining that the vehicle will not reach the final destination based on the battery charge status.

5. The system of claim 4, wherein the at least one controller reduces functionality of the one or more seat operations by performing one or more of: (i) reducing a magnitude of one of inflation and deflation for air bladders positioned on the seat assembly, (ii) reducing a time duration of the one of inflation and deflation for the air bladders, (iii) reducing a number of cycles that the air bladders are activated for, and (iv) cancelling the one of inflation and deflation for the air bladders.

6. The system of claim 4, wherein the at least one controller reduces the functionality by performing one or more of: (i) reducing a time duration of applying pulsated electromagnetic fields (PEMF) application, (ii) reducing a time duration for applying a heating operation to the seat assembly, and (iii) reducing a magnitude of the heating operation to the seat assembly.

7. The system of claim 4, wherein the at least one controller provides an inquiry on a user interface corresponding to an option for selection by a user to reduce the functionality of the one or more seat operations in response to determining that the vehicle will not reach the final destination based on the battery charge status.

8. The system of claim 2, wherein the at least one controller reduces functionality of the one or more seat operations based at least on the battery charge status and the vehicle stopping to travel for a time period that exceeds a predetermined time interval.

9. The system of claim 8, wherein the at least one controller determines that the vehicle occupant is no longer positioned on the seat assembly in response to an occupant detection signal.

10. The system of claim 9, wherein the at least one controller determines a new travel time for the vehicle to reach the final destination in response to one of: (i) the vehicle stopping to travel for a time period that exceeds the predetermined time interval, and (ii) the vehicle occupant no longer being positioned on the seat assembly.

11. The system of claim 10, wherein the at least one controller reduces functionality of the one or more seat operations in response to determining that the new travel time results in an increase in time in which the vehicle reaches the final destination.

12. The system of claim 8, wherein the at least one controller determines that the vehicle has reached a battery charging station based on one or more of: (i) receiving information transmitted from a navigation system indicating that the vehicle has reached the battery charging station and (ii) detecting that the one or more batteries in the vehicle are being charged.

13. The system of claim 2, wherein the at least one controller receives a third signal indicative of a distance to a new final destination for a vehicle.

14. The system of claim 13, wherein the at least one controller controls the one or more seat operations based at least on the battery charge status and the new final destination of the vehicle.

15. The system of claim 1, wherein the at least one controller receives an input signal indicative of the vehicle occupant's mood and controls the one or more seat operations based on the vehicle occupant's mood.

16. The system of claim 1, wherein the at least one controller receives a profile signal indicative of a user profile for the vehicle occupant and selectively activates or deactivates the one or more seat operations based on the user profile.

17. The system of claim 16, wherein the at least one controller selectively activates or deactivates the one or more seat operations without prompting the vehicle occupant.

18. The system of claim 17, wherein the at least one controller controls one or more vehicle operations based on degradation levels.

19. A method comprising:
executing, via at least one controller, one or more seat operations for a seat assembly of a vehicle; and
receiving a first signal indicative of battery charge status for one or more batteries; and
controlling the one or more seat operations based on at least the battery charge status.

20. A computer-program product embodied in a non-transitory computer read-able medium that is programmed for controlling one or more seat operations for a seat assembly, the computer-program product comprising instructions and being executable by at least one processor for:
performing one or more seat operations for a seat assembly of a vehicle; and
receiving a first signal indicative of battery charge status for one or more batteries; and
controlling the one or more seat operations based on at least the battery charge status.
